(19) United States
(12) Patent Application Publication
(10) Pub. No.: US 2005/0192684 A1
(43) Pub. Date: Sep. 1, 2005

(54) Device for automating machine tools or production machines

(75) Inventors: Ralf Friedrich, Herzogenaurach (DE); Stephan Greff, Erlangen (DE); Siegfried Hagedorn, Hemhofen (DE); Guido Seeger, Baiersdorf (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 11/014,630

(22) Filed: Dec. 16, 2004

(30) Foreign Application Priority Data
Dec. 17, 2003 (DE) 103 59 251.2

(51) Int. Cl. G05B 15/00

(52) U.S. Cl. 700/83

(57) ABSTRACT

A device is disclosed for automating machines, such as machine tools or production machines, whereby the device includes at least one local user terminal located proximate to a corresponding machine for operating that machine, at least one controller for controlling the corresponding machine connected with the local user terminal via a bus system, and at least one computer that is also connected to the bus system for unidirectional or bidirectional data transfer. The at least one computer includes operating software capable of controlling functions of the machine(s) and can be operated from the user terminal(s). The disclosed device optimizes the operation of a machine tool or production machine in an automation environment.

### CROSS-REFERENCES TO RELATED APPLICATIONS

This application claims the priority of German Patent Application, Serial No. 103 59 251.2, filed Dec. 17, 2003, pursuant to 35 U.S.C. 119(a)-(d).

### BACKGROUND OF THE INVENTION

The present invention relates to a device for automating a machine, and more particular to a device for automating a machine tool or production machine.

Nothing in the following discussion of the state of the art is to be construed as an admission of prior art.

The various components of an automation device or facility are typically connected with each other in form of a network via a bus system. For example, several production machines or machine tools can be connected with each other and with, for example, a service PC and/or a simulator via a common bus system. Each machine tool or production machine can include a corresponding user terminal located in close proximity of the machine tool or production machine. Conversely, the service PC or simulator are frequently implemented in a different computing device and placed remote from the machine tool or production machine, so that they can be used for several machines simultaneously to provide cost savings. For example, the machine tools or production machines may be placed inside a factory building, whereas the service PC and/or the simulator are housed separately.

The service PC is used, for example, to read and analyze alarm messages or specific internal parameters, for example, of a machine controller in the event of a malfunction, thereafter displaying the messages and parameters. The simulator can be used to simulate the production and/or process flow within a single machine or between different machines, for example, to optimize control parameters for a machine, which are then transmitted to the user terminal and then to the machine controller. In actual situations, when such automation devices are installed, a machine can no longer to be operated from the user terminal located close to the machine because important functions required for optimally controlling the machine are no longer available at the user terminal, but are instead implemented on the service PC or the simulator. Therefore, when using conventional automation devices, a user may have to walk quite a long way to gain control of the various machines because the machines can no longer be fully operated on-site. In other words, if a malfunction occurs or a simulation is to be performed, the user may have to walk from the installation site of the machine to the service PC or simulator in order to perform these tasks, and then return to the user terminal of the machine, or optionally carry a transportable service PC to the machine. Moreover, the simulation results are visualized or the service is performed on the service PC at a location different from that of the machine, making it difficult to directly compare the simulation results on-site with the operating characteristics of the actual machine.

It would therefore be desirable and advantageous to provide an improved automation device that optimizes the operation of a machine tool or production machine.

### SUMMARY OF THE INVENTION

According to one aspect of the invention, a device for automating a machine includes a local user terminal located proximate to the machine for operating the machine, a controller that controls the machine and is connected via a bus system with the local user terminal, and a computer having operating software capable of controlling functions of the machine. The computer is connected to the bus system for unidirectional or bidirectional data transfer and operated from the user terminal.

The machine can be a machine tool or production machine. Moreover, the device can include a plurality of machines, each having an associated therewith a corresponding user terminal and a corresponding controller, as well as a plurality of computers, all of which are connected via the bus system in the manner described above.

Machine tools in the context of the present invention can also include, for example, uniaxial or multi-axis lathes, milling machines, as well as drilling or grinding machines. Machine tools can further include processing centers, linear and rotary transfer machines, laser machines, rolling machines and/or gear cutters. These machines have in common that the material is machined along several axes. Production machines in the context of the present invention can include textile, paper, plastic, wood, glass, ceramic or stone processing machines, as well as machines used for forming, packaging, printing, conveying, lifting, pumping, transporting. Furthermore, fans, blowers, wind turbines, lifting gear, cranes, robots, production and assembly lines are also included under the term production machines in the context of the present invention.

According to one advantageous feature of the invention, the operating software that controls functions of the machine may be set up so that it executes only in the controller, which can minimize the required hardware and software requirements of the controller.

According to another advantageous feature of the invention, the device can further include a human-machine-interface (HMI) computer that is connected with the bus system for unidirectional or bidirectional data transfer, whereby the operating software that controls machine functions is executed only in the HMI computer. In this way, several user terminals can access common operating software and the required hardware or software within the individual user terminals can be minimized.

According to yet another advantageous feature of the invention, the device can further include a service center, wherein the bus system can be connected with the service center via the Internet. The service center can be set up for bidirectional data transfer with the bus system, whereby the data from the service center can be visualized on the user terminal, i.e., close to the machine.

According to still another advantageous feature of the invention, the user terminal, the controller and/or the computer can include identification tags that enable the HMI computer and/or the service center to automatically identify the corresponding user terminal, controller and/or computer.

According to yet another advantageous feature of the invention, the bus system can be implemented as an Ethernet bus system, which is one example of various widely used bus systems. It will be understood that other bus systems that are capable of connecting and transferring data between computing devices, controller, sensors and other components can also be used.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a first embodiment of a device for automating machine tools or production machines according to the invention, with operating software running in an HMI computer; and

FIG. 2 shows a second embodiment of a device for automating machine tools or production machines according to the invention, with operating software running in the machine controllers.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

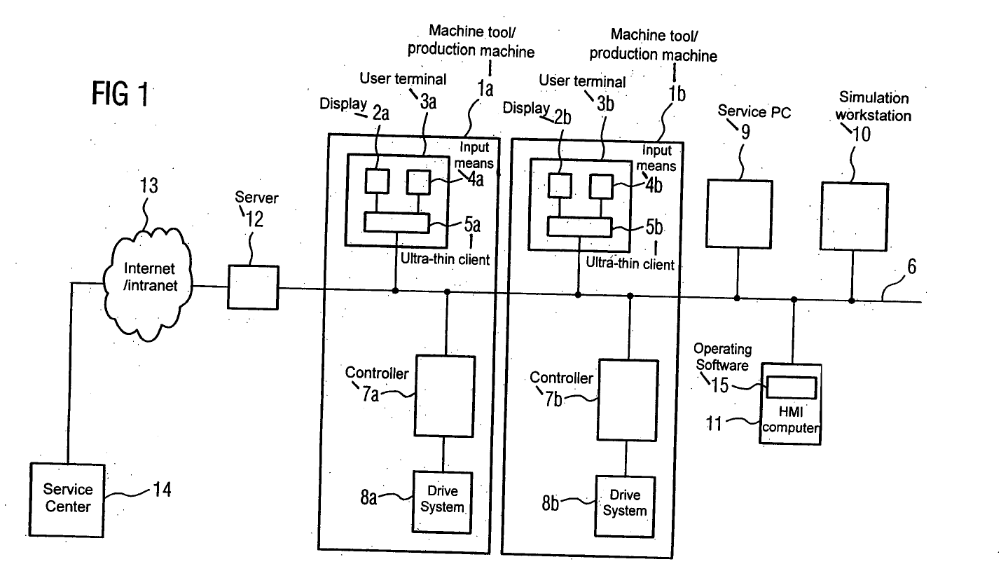

Turning now to the drawing, and in particular to FIG. 1, there is shown in form of a schematic block diagram a first embodiment of a device for automating a machine, such as a machine tool or production machine, according to the invention. The device includes, by way of example, two production machines 1a and 1b, two computing devices 9 and 10, a bus system 6, an HMI (human-machine-interface) computer 11, and a service center 14. The service center 14 is connected to the bus system 6 via the Internet 13 and via a server 12, which can include firewall functionality. It will be understood, that additional computing devices and/or additional production machines and/or machine tools can be connected to the bus system 6. Each of the production machines 1a and 1b includes a corresponding user terminal 3a and 3b for operating the respective machine, as well as a corresponding controller 7a and 7b, and an associated drive system 8a and 8b, respectively. The controller 7a and the drive system 8a can be operated from the user terminal 3a, whereas the controller 7b and the drive system 8b can be operated from the user terminal 3b. It will be understood that the production machines 1a and 1b can include additional components which are not essential for the present invention and have therefore been omitted for sake of clarity.

Each of the user terminals 3a, 3b includes a corresponding display screen 2a, 2b for visualization as well as input means 4a, 4b, which can be implemented, for example, in form of a keyboard, a mouse, a trackball, a touchpad and/or a touch screen, voice input, and the like. In the embodiment is depicted in FIG. 1, the computing device 9 is implemented as a service PC 9 connected to the bus system 6, whereas the computing device 10 is implemented as a simulation workstation or simulator 10 which is also connected to the bus system 6. The service PC 9 can be used, for example, to display alarm messages, for example to indicate a malfunction of the production machines 1a, 1b, and/or to change or visualize internal parameters of the controller 1a and 1b, respectively, that cannot be changed from the user terminal 3a, 3b. For example, the simulation workstation 10 can be used to simulate, analyze, optimize and visualize the manufacturing or production process, and to optimize control parameters for parameterizing the controllers 7a, 7b. Accordingly, generally useful functionalities for controlling the machine are implemented in the controllers 9 and 10.

According to the invention, unlike conventional automation devices, the service PC 9 and the simulation workstation 10 can be operated from the user terminals 3a, 3b. Stated differently, the user can access and fully operate the service PC 9 and the simulation workstation 10 from any of the user terminals 3a, 3b located in close proximity to a corresponding production machine 1a, 1b. In an equivalent logic diagram, the service PC 9 and the simulation workstation 10 would then appear as being part of the user terminal 3a, 3b. The visualization presented to the user on the user terminals 3a, 3b is then identical or similar to the visualization presented on a display screen of the service PC 9 or the simulation workstation 10. Moreover, the user can operate the service PC 9 or the simulation workstation 10 via the user terminal 3a, 3b by using the input means 4a, 4b in the same manner or in a similar manner as if (s)he were physically located directly in front of the service PC 9 or on the simulation workstation 10.

Unlike with conventional devices for automating machine tools or production machines, the user can fully operate a production machine 1a or 1b with the device of the invention via the user terminal 3a, 3b associated with that machine. For example, the production machine 1a can be started up entirely and directly from the user terminal 3a, because operations that are typically performed during the start-up phase of the machine by the service PC can now also be performed from the user terminal 3a. The same applies to any required simulations, for example when testing a new parts program for the controllers 7a and 7b.

In the embodiment of FIG. 1, the operating software 15 that operates the controller 7a, 7b and/or the service PC 9 and the simulation workstation 10 is advantageously no longer executed in the user terminals 3a and 3b themselves, but instead by a separate so-called HMI (human-machine-interface) computer 11. In this way, the controllers 7a, 7b, the service PC 9 and the simulation workstation 10 can now advantageously be operated from the user terminals 3a and 3b using universal operating software 15 running in the HMI computer 11. Because the operating software 15 is no longer executed in the user terminals 3a and 3b, the user terminals 3a, 3b do not need to have their own intelligence and can instead be implemented as so-called ultra-thin-clients 5a, 5b connecting the corresponding display screens 2a, 2b and the input means 4a, 4b with the bus system 6. The ultra thin clients 5a, 5b merely convert the signals to and from the display screen 2a, 2b, as well as the signals of the input means 4a, 4b into a data format that can be read by the bus system 6. The data are then interpreted by the operating software 15, which also interprets, for example, keystrokes received from the input means 4a, 4b, and returns the user messages about the manufacturing and/or production process, and also controls the visualization on the display screens 2a, 2b.

In the embodiment of FIG. 1, the bus system 6 also connects to a server 12 which is connected with the service center 14, for example, via the Internet 13 or an intranet. The service center 14 can be used, for example, to archive data, but is not essential for implementing the invention. Such data can include events or alarms that occurred during the manufacturing or production process, and/or software states and parts programs that can later support service on the machine. The user can access the data stored in the service center 14 on-site, i.e., at the location of the machine, via the respective user terminal 3a, 3b, by using, for example, a browser. Alternatively or in addition, the service center 14 can also store data from the controllers 7a, 7b, from the HMI computer 11, from the service PC 9, from the simulation workstation 10, as well as from the user terminals 3a, 3b.

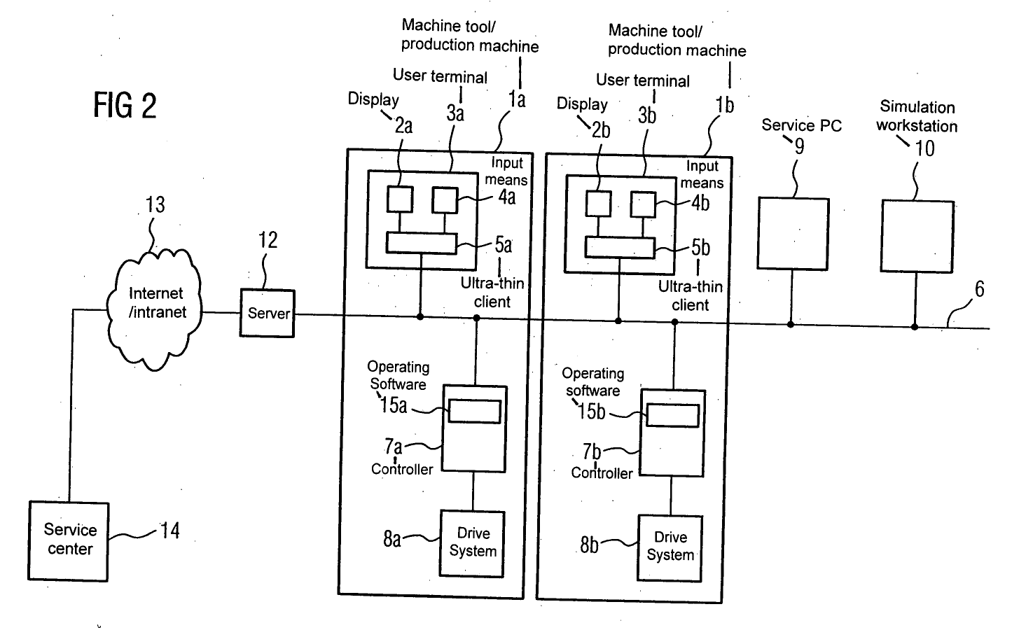

FIG. 2 shows another embodiment of the device according to the invention. The embodiment of FIG. 2 is identical with the embodiment of FIG. 1 with the exception that the operating software 15 is no longer executed on a separate HMI computer 11, but forms an integral component 15a, 15b of the respective controllers 7a, 7b. Since the controllers 7a and 7b already include a computer for executing the control functions, which typically has enough processing power for executing the operating software 15a and 15b, the HMI computer 11 can be eliminated. In one embodiment, the operating software 15a associated with the controller 7a of machine 1a can also operate the machine 1b in addition or instead of machine 1a, for example, when the controller 7b is already busy performing other tasks. The reference characters used for the other components in FIG. 2 are identical to those used in FIG. 1.

Advantageously, the bus system in both embodiments can be implemented as an Ethernet bus system which is known to have a sufficiently high data throughput, although other suitable bus systems can also be employed.

Moreover, other computing devices, which can include additional specific functions to be accessed by the user terminals 3a and 3b, can be connected to the bus system 6 in addition to the service PC 9 and the simulation workstation 10.

In addition, the user terminals, the controllers and the computers and other optional devices can have an identification tag that uniquely identifies these devices. The HMI computer or optionally the service center can use these identification tags for automatically identifying the layout of the automation device, whereby components of the automation device can be removed or inserted during the operation (hot-swap).

Moreover, additional computing devices performing different functions can be connected in addition to the two computers/workstations 9 and 10. For example, the additional computing devices can take over functions that are otherwise performed by the control software controlling the drive system 8a and/or 8b, thereby reducing the processing load of the controllers 7a, 7b.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A device for automating a machine, comprising:
a local user terminal located proximate to the machine for operating the machine;
a controller for controlling the machine connected via a bus system with the local user terminal; and
a computer having operating software capable of controlling functions of the machine, said computer connected to the bus system for unidirectional or bidirectional data transfer and operated from the user terminal.

2. The device of claim 1, wherein the operating software for controlling functions of the machine is executed only in the controller.

3. The device of claim 1, further comprising an HMI computer that is connected with the bus system for unidirectional or bidirectional data transfer, with the operating software for controlling functions of the machine being executed only on the HMI computer.

4. The device of claim 1, further comprising a service center, wherein the bus system is connected with the service center via the Internet, said service center capable of bidirectional data transfer with the bus system, with the data being visualized on the user terminal.

5. The device of claim 3, wherein at least one of the user terminal, the controller and the computer includes an identification tag that enables the HMI computer to identify the corresponding user terminal, controller and computer.

6. The device of claim 3, wherein at least one of the user terminal, the controller and the computer includes an identification tag that enables the service center to identify the corresponding user terminal, controller and computer.

7. The device of claim 1, wherein the bus system is implemented as an Ethernet bus system.

8. The device of claim 1, wherein the machine comprises a machine tool or a production machine.

9. The device of claim 1, comprising at least two machines, and at least two local user terminals and at least two controllers associated with the machines in one-to-one correspondence, wherein the operating software is executed in at least one of the controllers.

10. The device of claim 9, wherein the operating software executed in a first of the at least two controllers operates a machine associated with another of the at least two controllers.
